(19) United States
(12) Patent Application Publication
(10) Pub. No.: US 2006/0097706 A1
(43) Pub. Date: May 11, 2006

(54) DC-DC converter

(75) Inventors: Huel-Lin Lai, Shulin City (TW); Chin-Ping Wei, Shulin City (TW)

Correspondence Address: TROXELL LAW OFFICE PLLC, SUITE 1404, 5205 LEESBURG PIKE, FALLS CHURCH, VA, 22041, US

(73) Assignee: L & K Prescision Technology Co., Ltd.

(21) Appl. No.: 10/981,518

(22) Filed: Nov. 5, 2004

(51) Int. Cl. G05F 1/656

(52) U.S. Cl. 323/222

(57) ABSTRACT

A DC-DC converter is used for raising input voltage, and has a substrate forming a plurality of conductive pins, and a circuit system formed on the substrate and appropriately coupled to the conductive pins. The circuit system includes a step-up circuit coupled in series to a MOSFET with threshold voltage of 20V. A Zener diode and a diode are coupled in parallel between two transistors of the step-up circuit and are coupled in series with each other for limiting working voltage of the step-up circuit no more than 20V thereby assuring MOSFET working normally and preventing damage of electronic components in the DC-DC converter.

### BACKGROUND OF THE INVENTION

1. Field of the Invention

The present invention relates to a DC-DC converter, and particularly to a DC-DC converter having stable expected voltage through a step-up circuit thereby protecting electronic components therein from impairment because of loading over-high voltage.

2. Related Art

DC-DC converters are popularly used in integrated circuits of a variety of electronic products, for instance, walkman, digital camera, wireless phone and portable medical devices. DC-DC converters often have step-up circuits for raising input voltage. However, boost ratio of the step-up circuit in prior art is linear. Therefore, once an input voltage exceeds a threshold, consequently a working voltage of the step-up circuit exceeds a predetermined threshold, which tends to damage electronic components in the circuit system.

Referring to FIG. 1, a circuit system 1, which is adapted for a DC-DC converter, comprises a MOSFET (metallic oxide semiconductor field effect transistor) 10, a step-up circuit 11 coupled to the MOSFET 10 for increasing input voltage. The MOSFET 10 works under a working voltage Vgs and has a predetermined threshold voltage 20V. In the step-up circuit 11, voltage of VCC, a diode D4 and a capacitance C8 feedback to voltage VDD to activate a transistor Q1. For example, provided that the input voltage is 12V, voltage VA is about equal to VCC, that is 12V, and VDD is 24V. The working voltage Vgs of the transistor Q1 is the result of VDD subtracting VA (Q1=VDD−VA), that is 12V.

However, once the input voltage exceeds a threshold voltage 20V, VDD exceeds 40V, and correspondingly, the working voltage Vgs of transistor Q1 exceeds 20V (Vgs=VDD−VA). The transistor Q1 and MOSFET 10 tends to damage for much too high working voltage.

### SUMMARY OF THE INVENTION

Accordingly, an object of the present invention is to provide a DC-DC converter, which has stable expected voltage through a step-up circuit thereby protecting electronic components therein from impairment because of loading over-high voltage.

The step-up circuit of the DC-DC converter comprises a Zener diode and a diode which are coupled in parallel between two transistors and are coupled in series with each other for limiting working voltage Vgs of the step-up circuit no more than 20V thereby assuring MOSFET of the DC-DC converter working normally.

### BRIEF DESCRIPTION OF THE DRAWINGS

FIG. 1 is a circuit diagram of a step-up circuit of a DC-DC converter of prior art.

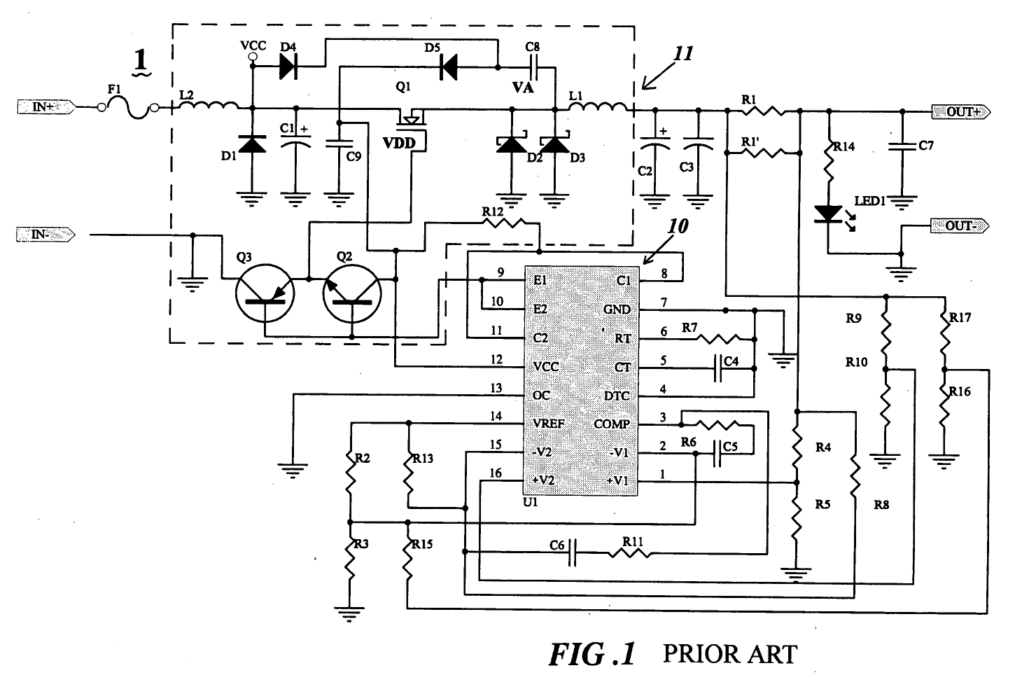

FIG. 2 is a circuit diagram of a DC-DC converter of a step-up circuit of the present invention.

### DESCRIPTION OF THE PREFERRED EMBODIMENTS

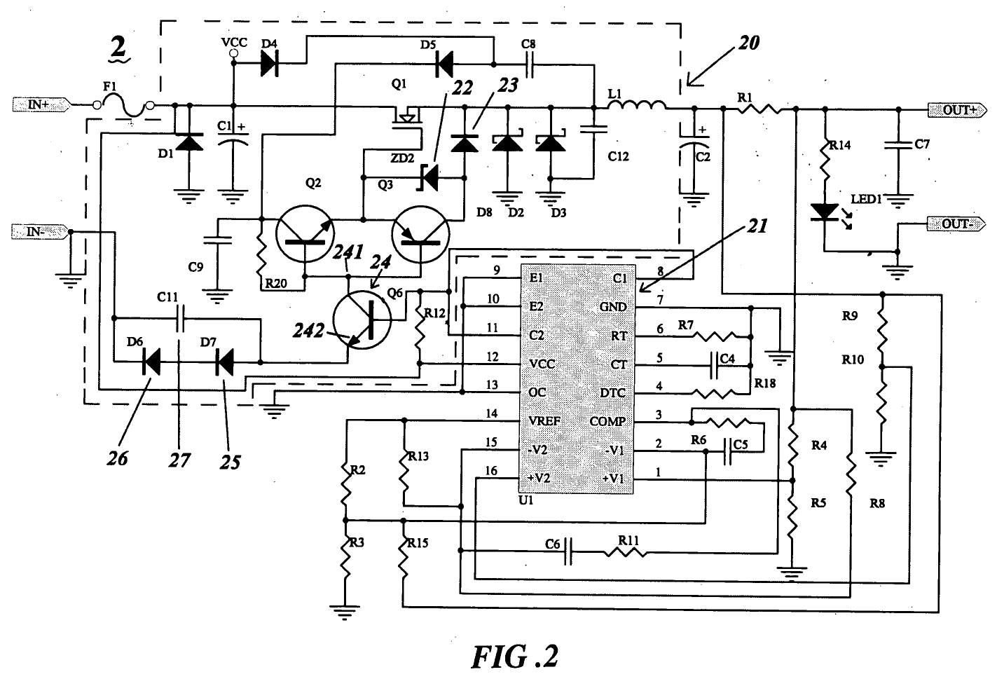

With reference to FIG. 2, a DC-DC converter of the present invention comprises a substrate (not shown) forming a plurality of conductive pins, and a circuit system 2 formed on the substrate and appropriately connected with the conductive pins. The circuit system 2 has a step-up circuit 20 coupled in series to a MOSFET 21. The MOSFET 21 has a predetermined threshold voltage of 20V. Correspondingly working voltage Vgs of the transistor Q1 has a threshold voltage 20V. A Zener diode 22 is coupled in parallel between a transistor Q2 and a transistor Q3 of the step-up circuit 20 for preventing working voltage Vgs from exceeding the threshold 20V. Preferably, the Zener diode 22 is the type ranged from 15V to 18V. In this embodiment, the Zener diode 22 is 15V type. A diode 23 is in series coupled to the Zener diode 22 for cooperating with the Zener diode 22. Preferably, the diode 23 is the type ranged from 0.5V to 0.7V. In this embodiment, the diode 23 is 0.7V type. An NPN type transistor 24 has a collector 241 in parallel coupled to the Zener diode 22, and an emitter 242 in series coupled to an input cathode 30. Furthermore, two diodes 25, 26 couple with each other in series, and are in series coupled to the emitter 242 of the NPN type transistor 24 and in parallel coupled to a capacitance 27.

Once input voltage exceeds 20V, VDD is equal to sum of VCC and voltage of C8 (VDD=VCC+C8), and so exceeds 40V. Vgs of the transistor Q1 is the result of VDD subtracting VA (Q1=VDD−VA), and so exceeds 20V. Meanwhile the Zener diode 22 and the diode 23 are activated to limit the Vgs to 15.7V because at the same time the Vgs is the sum of voltage 15V of the Zener diode 22 and voltage 0.7V of the diode 23. Thus, the working voltage Vgs maintains no more than the threshold voltage 20V, thereby assuring the MOSFET working normally and preventing damage of the electronic components in the DC-DC converter. The diodes 25, 26 and the capacitance 27 preserve electric charges when the working voltage rises suddenly.

It is understood that the invention may be embodied in other forms without departing from the spirit thereof. Thus, the present examples and embodiments are to be considered in all respects as illustrative and not restrictive, and the invention is not to be limited to the details given herein.

1. A DC-DC converter, which is adapted to raise input voltage, comprising a substrate forming a plurality of conductive pins, and a circuit system formed on the substrate and appropriately coupled to the conductive pins, the circuit system including a step-up circuit coupled in series to a MOSFET with threshold voltage of 20V, wherein a Zener diode and a diode are coupled in parallel between two transistors of the step-up circuit and are coupled in series with each other for limiting working voltage of the step-up circuit no more than 20V thereby assuring MOSFET working normally.

2. The DC-DC converter as claimed in claim 1, wherein the Zener diode is the type ranged from 15V to 18V.

3. The DC-DC converter as claimed in claim 1, wherein the diode coupled in series to the Zener diode is the type ranged from 0.5V to 0.7V.

4. The DC-DC converter as claimed in claim 1, further comprises an NPN type transistor, and wherein the NPN type transistor has a collector in parallel coupled to the Zener diode, and an emitter in series coupled to an input cathode.

5. The DC-DC converter as claimed in claim 4, further comprising two diodes coupled in series with each other, and coupled in series to the emitter of the NPN type transistor and in parallel to a capacitance.
